(19) United States
(12) Patent Application Publication
(10) Pub. No.: US 2011/0079112 A1
(43) Pub. Date: Apr. 7, 2011

(54) Screwdriver with Changeable Blade

(76) Inventor: Jack LIN, Taichung City (TW)

(21) Appl. No.: 12/573,109

(22) Filed: Oct. 3, 2009

(51) Int. Cl. B25B 23/00

(52) U.S. Cl. 81/59.1; 81/451

(57) ABSTRACT

A screwdriver includes a handle, a bit and a chuck for connecting the bit to the handle. The chuck includes a cylinder, two latches, a spring and a control element. The cylinder is securely connected to the handle. The latches are used to keep the bit connected to the cylinder, a spring for pushing the bit from the cylinder when the latches release the bit and a control element operable for causing the latches to release the bit.

### BACKGROUND OF INVENTION

1. Field of Invention

The present invention relates to a screwdriver and, more particularly, to a screwdriver with a changeable blade.

2. Related Prior Art

As disclosed in U.S. Pat. No. 7,458,296, a conventional screwdriver includes a handle 1, a blade 4, a chuck 2, a catch and a trigger 6. The chuck includes a plug-in opening 3 for receiving the blade 4. The catch is used to catch the blade 4. The catch includes a spring arm 7 extending axially along the periphery of the plug-in opening 3. The spring arm 7 includes a latching protrusion 5. The trigger 6 is axially movable. The trigger 6 includes an annular body 12 and a control element 8. The control element 8 is an axial extension of the annular body 12. The annular body 12 includes a through-opening 13 for receiving the blade 4. The control element 8 is used to move the latching protrusion 5 to a releasing position from a locking position. Sever problems are however encountered in the use of this conventional screwdriver. Firstly, the latch protrusion 5 could soon be worn out. Secondly, a specific annular groove must be made in the blade 4, and this is a troublesome and expensive process.

The present invention is therefore intended to obviate or at least alleviate the problems encountered in prior art.

### SUMMARY OF INVENTION

It is the primary objective of the present invention to provide a screwdriver with a changeable blade.

To achieve the foregoing objective, the screwdriver includes a handle, a bit and a chuck for connecting the bit to the handle. The chuck includes a cylinder, two latches, a spring and a control element. The cylinder is securely connected to the handle. The latches are used to keep the bit connected to the cylinder, a spring for pushing the bit from the cylinder when the latches release the bit and a control element operable for causing the latches to release the bit.

Other objectives, advantages and features of the present invention will be apparent from the following description referring to the drawings.

### BRIEF DESCRIPTION OF DRAWINGS

The present invention will be described via detailed illustration of three embodiments referring to the drawings.

FIG. 1 is a perspective view of a screwdriver according to the first embodiment of the present invention.

FIG. 2 is a partial, exploded view of the screwdriver shown in FIG. 1.

FIG. 3 is a cross-sectional view of the screwdriver shown in FIG. 1.

FIG. 4 is another cross-sectional view of the screwdriver of FIG. 3.

FIG. 5 is a cross-sectional view of the screwdriver in another position than shown in FIG. 4.

FIG. 6 is a cross-sectional view of the screwdriver in another position than shown in FIG. 5.

FIG. 7 is a cutaway view of the screwdriver shown in FIG. 1.

FIG. 8 is a cross-sectional view of the screwdriver in another position than shown in FIG. 6.

FIG. 9 is a partial, perspective view of a screwdriver according to the second embodiment of the present invention.

FIG. 10 is a cross-sectional view of a screwdriver according to the third embodiment of the present invention.

### DETAILED DESCRIPTION OF EMBODIMENTS

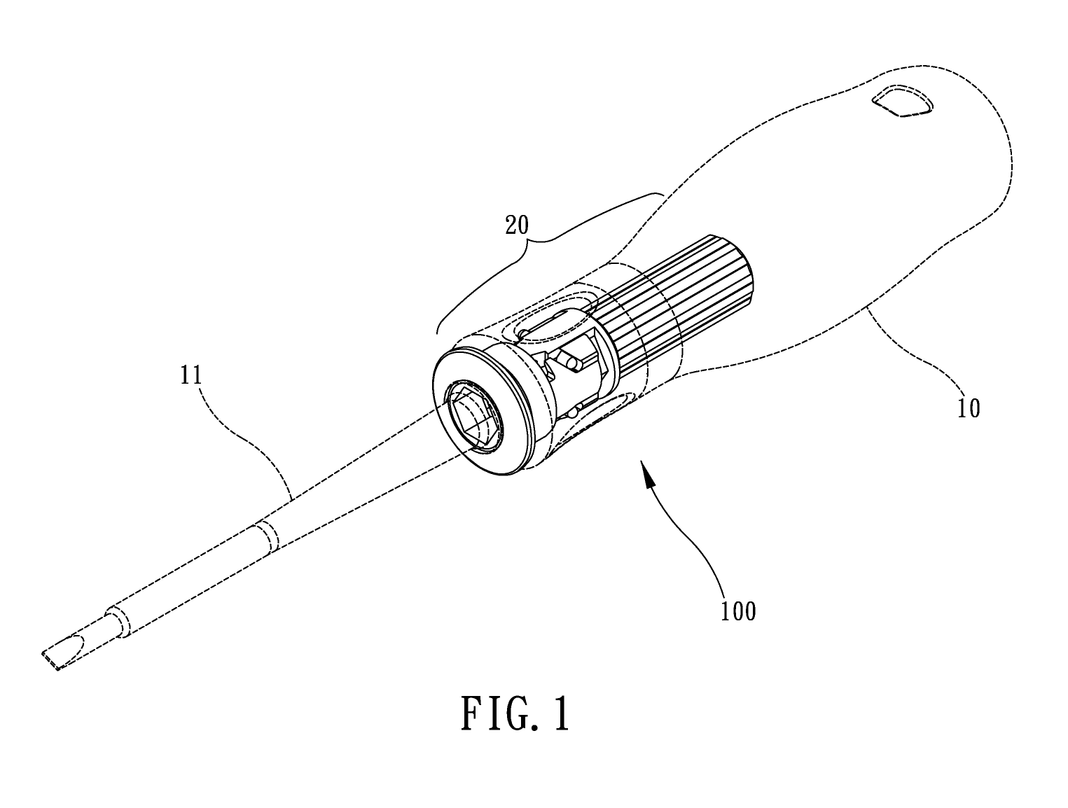

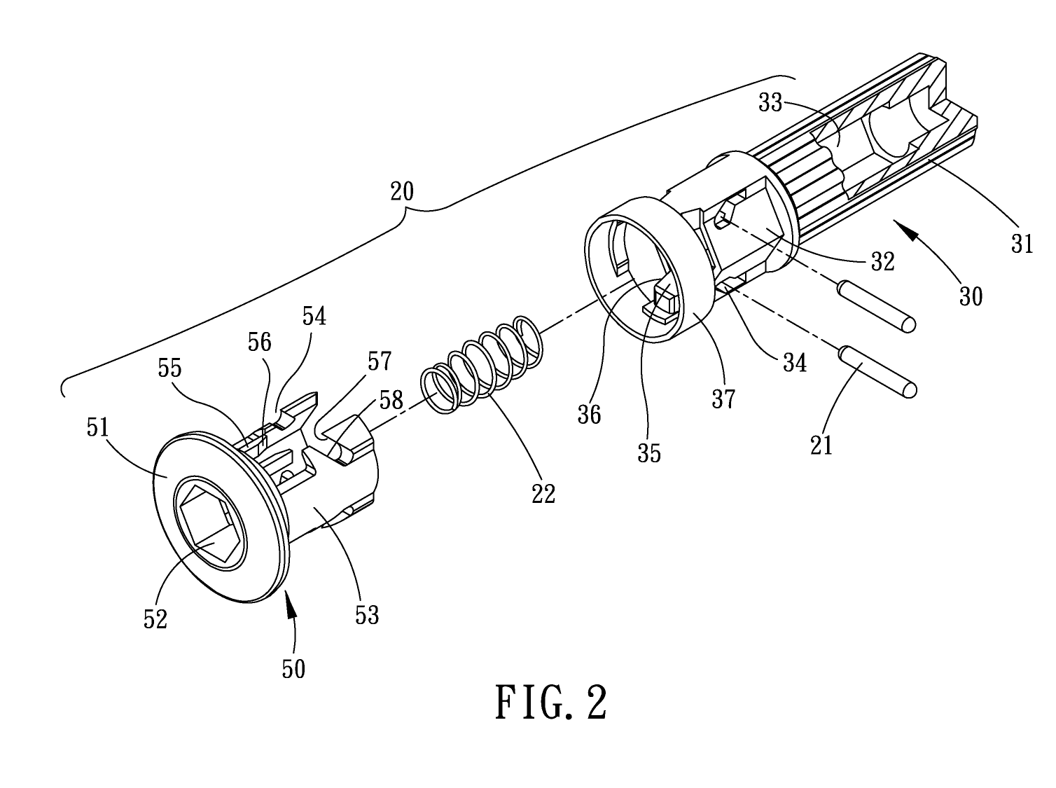

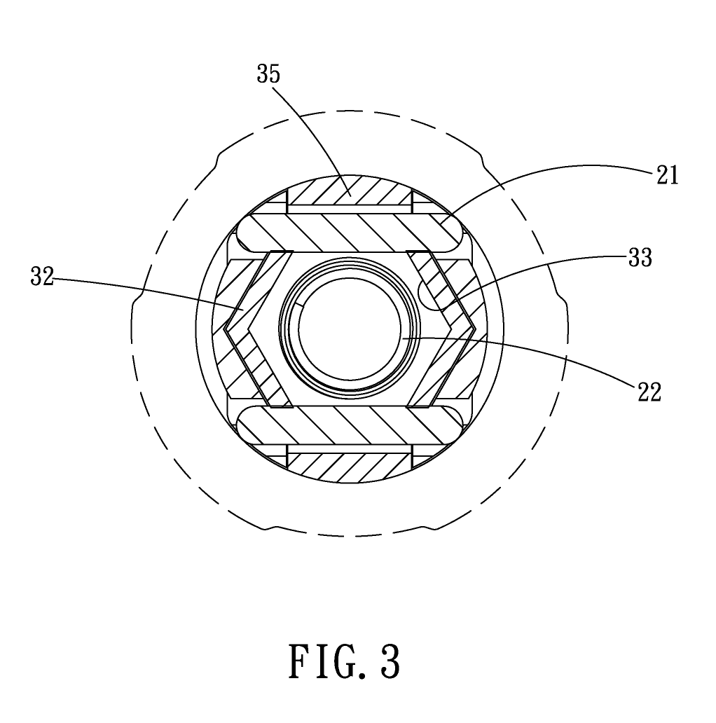

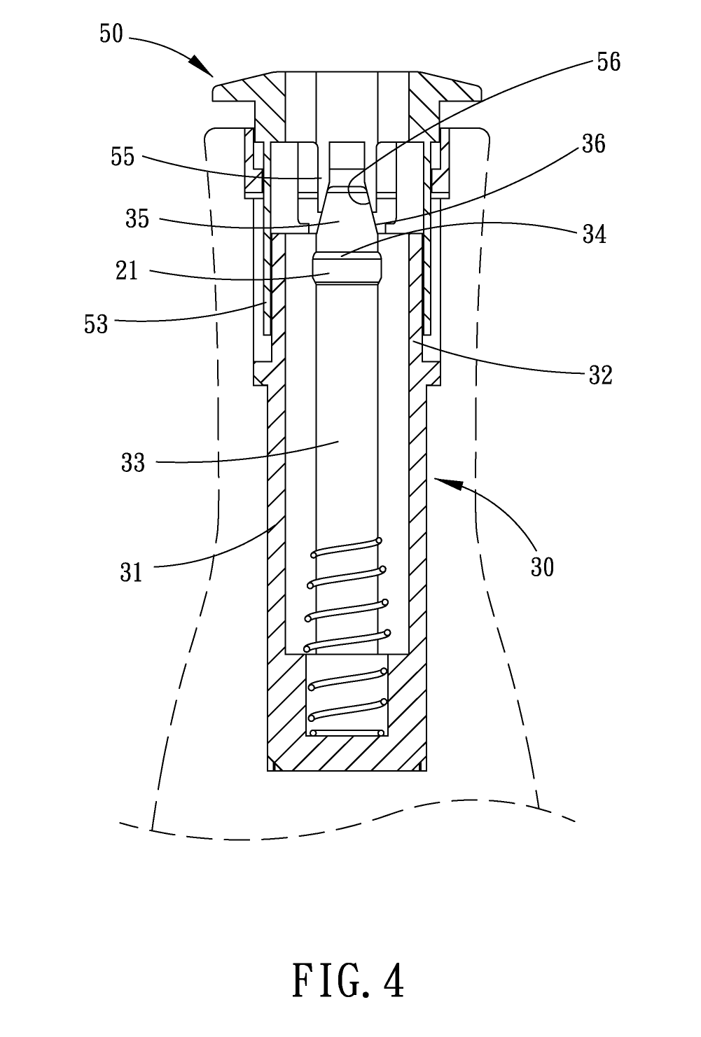

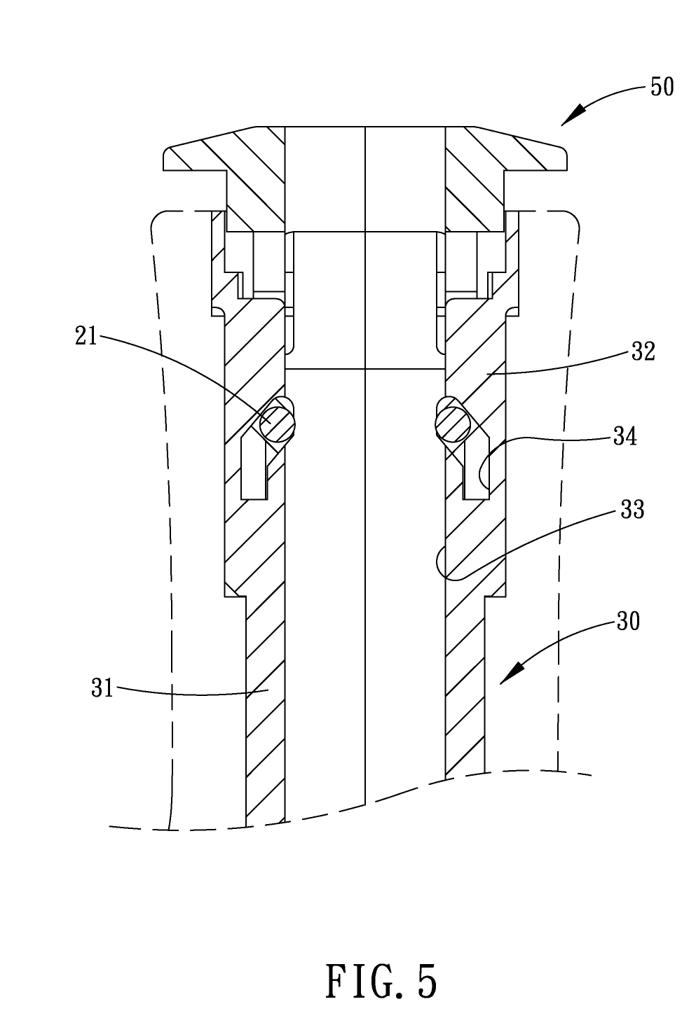

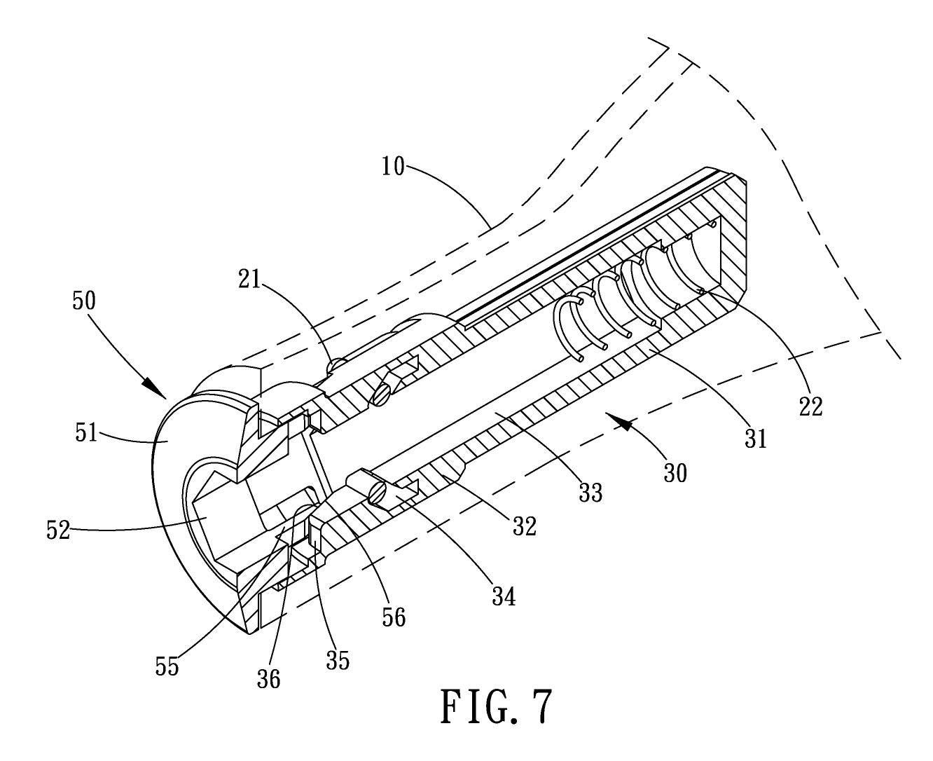

With reference to FIGS. 1 to 8, a screwdriver 100 includes a handle 10, a bit 11 and a chuck 20 for connecting the bit 11 to the handle 10 according to a first embodiment of the present invention. The handle 10 and the bit 11 will not be described in detail because they are typical. The chuck 20 includes a cylinder 30 securely connected to the handle 10, two latches 21 for keeping the bit 11 connected to the cylinder 30, a spring 22 for pushing the bit 11 from the cylinder 30 when the latches 21 release the bit 11 and a control element 50 operable for causing the latches 21 to release the bit 11.

The cylinder 30 includes a first section 31 and a second section 32. There are ribs formed on an external side of the first section 31 of the cylinder 30. Grooves are defined in an internal side of the handle 10. The ribs of the first section 31 of the cylinder 30 are inserted in the grooves of the handle 10, thus preventing the cylinder 30 from rotation relative to the handle 10. The external side of the first section 31 of the cylinder 30 and the internal side of the handle 10 can be made in any other matching non-circular shapes. Alternatively, a key can be used between the handle 10 and the first section 31 of the cylinder 30.

The second section 32 of the cylinder 30 includes a hexagonal internal side for engagement with a hexagonal periphery of the bit 11, thus preventing the bit 11 from rotation relative to the cylinder 30. The internal side of the second section 32 of the cylinder 30 and the periphery of the bit 11 can be made in any other matching non-circular shapes.

The cylinder 30 includes a space 33 axially defined in of the sections 31 and 32 thereof and two slots 34 transversely defined in the second section 32 thereof. Each of the slots 34 includes a first portion in communication with the space 33 and a second portion separated from the space 33. Moreover, the cylinder 30 includes two wedges 35 extended from the second section 32 thereof and a ring 37 also extended from the second section 32 thereof. The wedges 35 are located in but separated from the ring 37. Each of the wedges 35 is formed with a slope 36.

The control element 50 includes a button 51, a hexagonal opening 52, two plates 53 and two elastic strips 55. The hexagonal opening 52 is defined in the button 51. The hexagonal periphery of the bit 11 can be inserted through the hexagonal opening 52. Each of two plates 53 extends from the annular button 51 and includes two slits 54 defined therein obliquely relative to a length thereof. Each of the slits 54 is defined between a first edge 57 and a second edge 58. Each of the elastic strips 55 is formed with a slope 56 for sliding on the slope 36 of a related one of the wedges 35.

The plates 53 of the control element 50 are inserted through a gap defined between the ring 37 and the wedges 35 of the cylinder 30 so that the second section 32 of the cylinder 30 is located between the plates 53 of the control element 50. Each of the slits 54 of each of the plates 53 is in communication with a related one of the slots 34. The slopes 56 of the elastic strips 55 of the control element 50 can slide on the slopes 36 of the wedges 35 of the cylinder 30 so that the control element 50 tends to move from the cylinder 30.

Each of the latches 21 is in the form of a rod inserted in a related one of the slots 34 through a related one of the slits 54 so that the plates 53 are kept in the vicinity of the second section 32 of the cylinder 30. Each latch 21 is formed with a middle section movable in the related slot 34 and two terminal sections each movable in the related slit 54.

As mentioned above, the contact of the elastic strips 55 of the control element 50 with the wedges 35 of the cylinder 30 tends to move the control element 50 from the cylinder 30. Hence, there is a trend that the first edges 57 of the slits 54 push the middle sections of the latches 21 into the first sections of the slots 34.

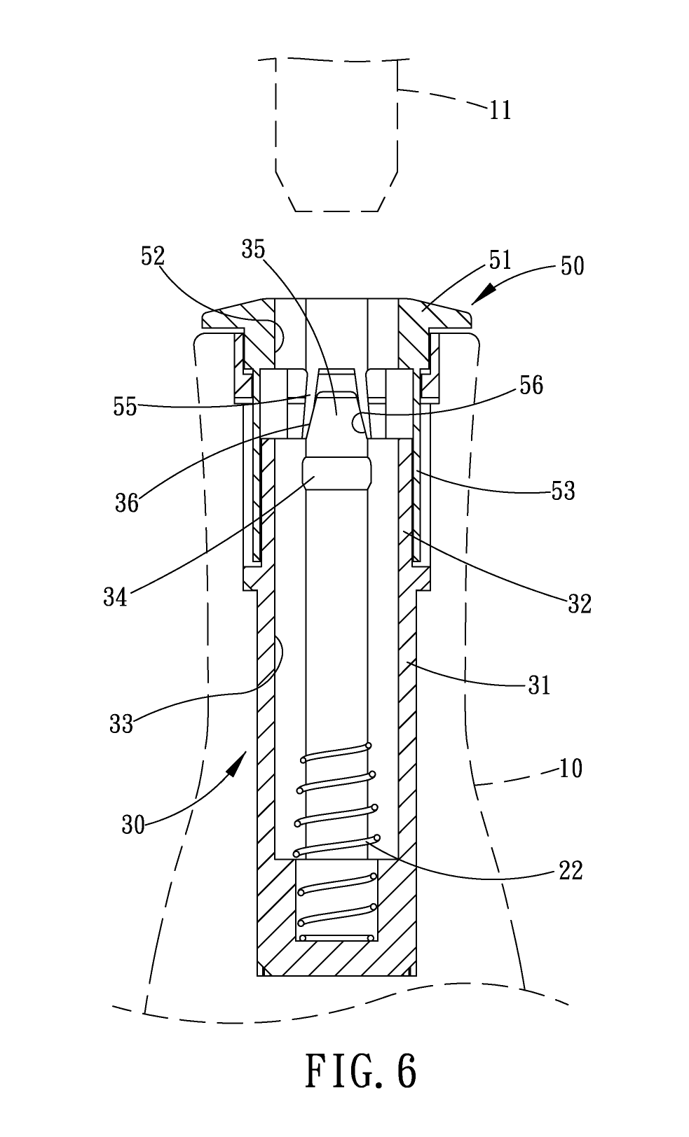

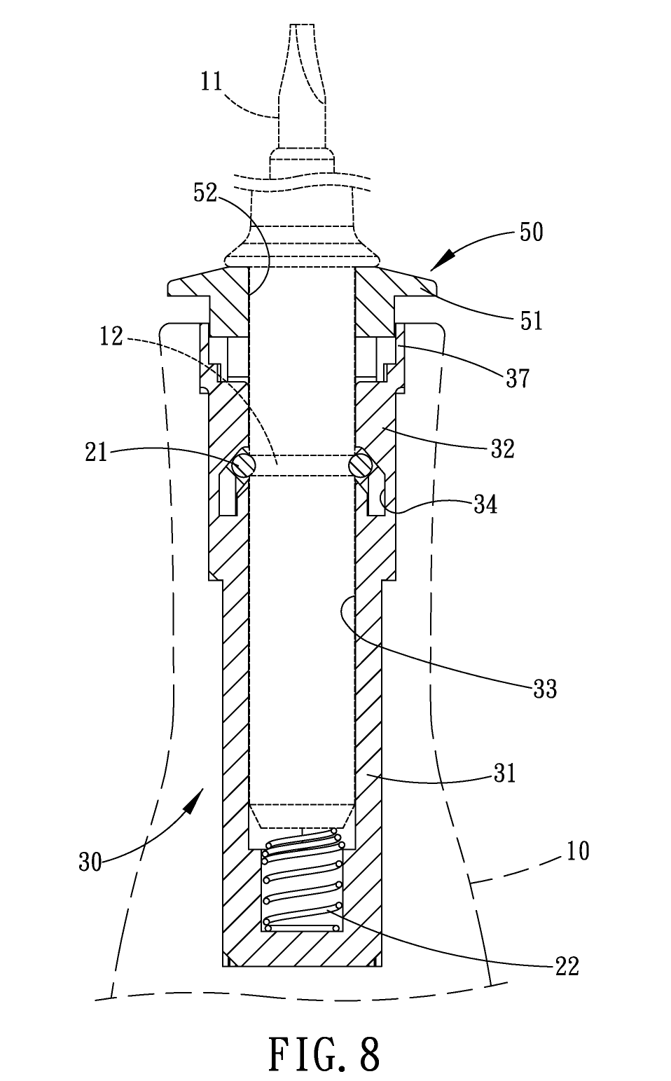

Referring to FIGS. 6 and 8, the bit 11 is inserted in the cylinder 30 through the control element 50. The insertion can be conducted in two manners. Firstly, the bit 11 is forced into the cylinder 30. Thus, an end of the bit 11 pushes the latches 21 to the second portions of the slots 34 and causes the control element 50 to move towards the cylinder 30 against the force of the elastic strips 55.

Secondly, the button 51 is pushed so that the second edges 58 of the slits 54 push the middle sections of the latches 21 to the second portions of the slots 34. Thus, the end of the bit 11 can be inserted into the cylinder 30.

The force exerted on the bit 11 or the button 51 is stopped when the end of the bit 11 is inserted in the cylinder 30 via the control element 50. Immediately, the elastic strips 55 cooperate with the wedges 35 to move the control element 50 from the cylinder 30, thus causing the first edges 57 of the slits 54 to push the middle sections of the latches 21 into the first sections of the slots 34. The middle section of each latch 21 is inserted through a portion of an annular groove defined in the periphery of the bit 11 while two terminal sections of the same are transversely inserted through the cylinder 30. Therefore, the latches 21 keep the bit 11 within the cylinder 30.

The spring 22 is located in the space 33. The spring 22 is compressed between the bit 11 and a closed end of the space 33 when the bit 11 is inserted in the space 33. Thus, the spring 22 pushes the bit 11 from the closed end of the cylinder 30 on the moment when the latches 21 release the bit 11.

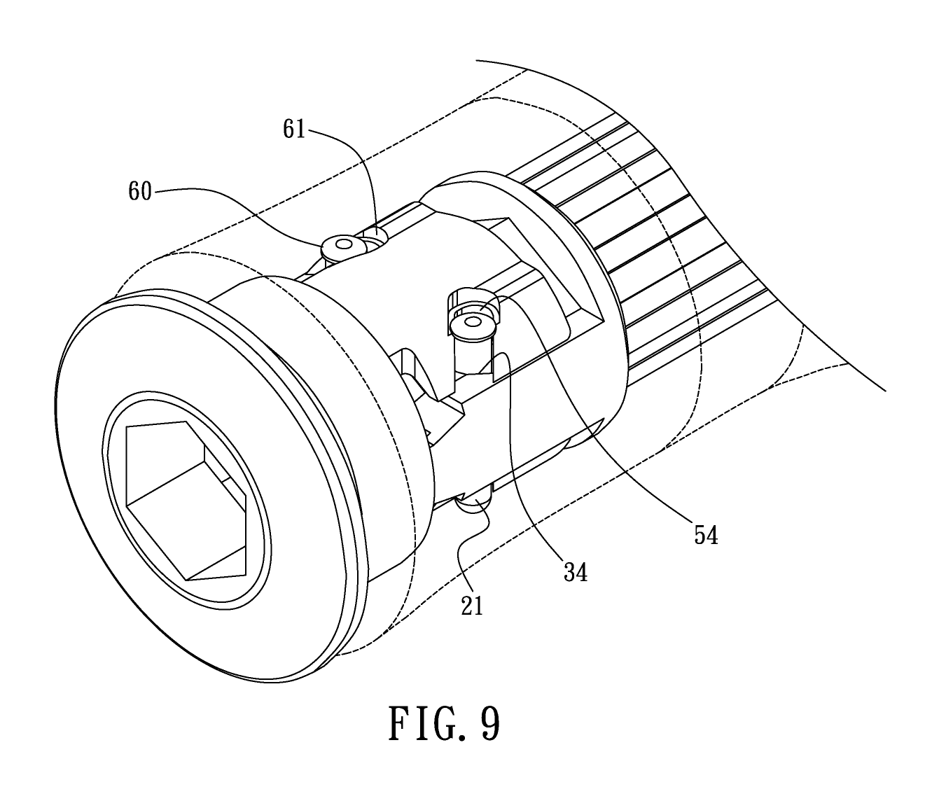

Referring to FIG. 9, a screwdriver according to a second embodiment of the present invention is shown. The second embodiment is like the first embodiment except two things. Firstly, each of the latches 21 includes two enlarged ends 60. Each of the slits 54 is in communication with a cavity 61 defined in each of the plates 53. The diameter of the enlarged ends 60 of the latches 21 is larger than the width of the slits 54, thus retaining the latches 21 within the slits 54 and the slots 34. The width of the cavities 61 is larger than the diameter of the enlarged ends 60 of the latches 21.

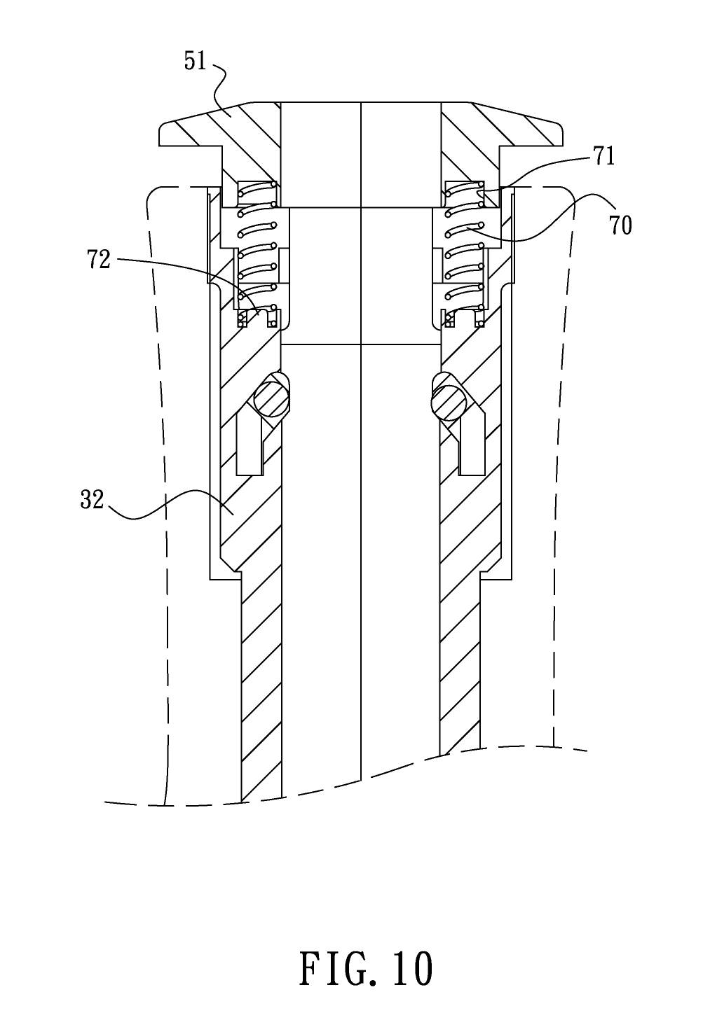

Referring to FIG. 10, a screwdriver according to a third embodiment of the present invention is shown. The third embodiment is like the first embodiment except including two springs 70 compressed between the control element 50 and the cylinder 30 instead of the elastic strips 55 abutted against the wedges 35. To position the springs 70, the control element 50 includes recesses 71 each for receiving an end of a related one of the springs 70, and the cylinder 30 includes two bosses 72 each inserted in an opposite end of a related one of the springs 70.

The present invention has been described via the detailed illustration of the embodiments. Those skilled in the art can derive variations from the embodiments without departing from the scope of the present invention. Therefore, the embodiments shall not limit the scope of the present invention defined in the claims.

1. A screwdriver comprising a handle, a bit and a chuck for connecting the bit to the handle, wherein the chuck comprises:
a cylinder securely connected to the handle and formed with a space and at least one slot including a first portion in communication with the space and a second portion separated from the space;
at least one latch inserted through the slot of the cylinder and movable between the first and second portions of the slot of the cylinder, wherein in the first portion of the slot, the latch can be inserted in an annular groove defined in the bit; and
a control element comprising a button comprising an opening for receiving the bit and two plates extending from the button and each comprising at least one slit for receiving the latch, wherein the control element is movable between a first position for pushing the latch to the first portion of the slot and a second position for pushing the latch to the second position.

2. The screwdriver according to claim 1, wherein the slits extend obliquely relative to the length of the plates.

3. The screwdriver according to claim 1, wherein the cylinder comprises two wedges formed thereon, and the control element comprises two elastic strips in contact with the wedges, thus retaining the control element in the first position.

4. The screwdriver according to claim 3, wherein the elastic element comprises a slope for sliding on a slope of the wedge.

5. The screwdriver according to claim 1 comprising at least one spring compressed between the cylinder and the control element.

6. The screwdriver according to claim 5, wherein the cylinder comprises at least one boss inserted in an end of the spring, and the control element comprises at least one recess for receiving an opposite end of the spring.

7. The screwdriver according to claim 1, wherein the latch comprises two enlarged ends for retaining the latch within the slot and the slits.

8. The screwdriver according to claim 1, wherein the cylinder comprises a first section securely connected to the handle and a second section for non-rotationally receiving the bit.
